(19) United States
(12) Patent Application Publication
(10) Pub. No.: US 2026/0016301 A1
(43) Pub. Date: Jan. 15, 2026

(54) DETERMINING ALTERNATE DESTINATIONS FOR A VESSEL

(71) Applicant: A.P. Møller - Mærsk A/S, Copenhagen (DK)

(72) Inventors: Manas MISHRA, Bangalore (IN); Dipankan BANDOPADHYAY, West Bengal (IN); Nivya TALOKAR, Bangalore (IN); Vinuta Vasant ANVEKAR, Bangalore (IN)

(21) Appl. No.: 19/332,991

(22) Filed: Sep. 18, 2025

Related U.S. Application Data
(63) Continuation of application No. PCT/DK2024/050037, filed on Feb. 26, 2024.

(30) Foreign Application Priority Data
Mar. 20, 2023 (DK) PA202300256

(51) Int. Cl. G01C 21/20; G06N 3/08

(52) U.S. Cl. CPC G01C 21/203; G06N 3/08

(57) ABSTRACT

A method, system and computer-readable storage medium, for determining an alternate target for a vessel. A route comprising a plurality of edges from a current position of the vessel, to at least a desired target is obtained from the vessel. Characteristics of at least one alternate target comprising historical vessel density data associated with at least one alternate target are obtained, and used by a trained machine learning model to forecast the vessel density at an estimated vessel arrival time for the vessel. A desired alternate target for the vessel is determined based on at least the forecasted vessel density, and the route is updated, such that it comprises a plurality of edges from the current position of the vessel to the desired alternate target. The route is then output to a control system associated with the vessel.

### CROSS-REFERENCE TO RELATED APPLICATIONS

This application is a continuation under 35 U.S.C. § 120 of International Application No. PCT/DK2024/050037, filed Feb. 26, 2024, which claims priority to Denmark Application No. PA202300256, filed Mar. 20, 2023, under 35 U.S.C. § 119 (a). Each of the above-referenced patent applications is incorporated by reference in its entirety.

### TECHNICAL FIELD

The present invention relates to a method, system and computer-readable storage medium for determining an alternate target for a vessel.

### BACKGROUND

In transportation and logistics, determining optimal routes and targets of a vessel is both time-intensive and costly to undertake. The automation of these determinations has been met with a number of complications due to the number of factors to be considered when determining an alternate route and corresponding alternate target.

Factors such as adverse weather conditions, congestion, and delays in accessing resources can all contribute to changes in a determined route and delays in arrivals to a given destination. Furthermore, changes in each of those conditions throughout a journey can result in further calculations being required to determine an alternative route and/or destination.

Undertaking this task for a large fleet of vessels is time-consuming, and costly, and whilst efforts have been made to attempt to automate some aspects of this process, they are particularly resource-intensive and computationally complex. Therefore, reducing the computational complexity and resource requirements for determining the alternative routes and/or destinations for a given vessel or fleet of vessels is desirable.

### SUMMARY

According to aspects of the present disclosure, there are provided a method, computer program product, such as a non-transitory storage medium comprising instructions for carrying out the method, and a system comprising a control system, storage, remote server and processor configured to perform the method.

The method is one of determining an alternate target for a vessel, the method comprising the steps of obtaining, from the vessel, at least a route, the route comprising a plurality of edges from a current position of the vessel, to at least a desired target; obtaining, from a remote server, characteristics of at least one alternate target, the characteristics comprising at least historical vessel density data associated with at least one alternate target; forecasting, using a trained machine learning model, vessel density at the at least one alternate target, at an estimated vessel arrival time for the vessel at the at least one alternate target based on the characteristics; determining a desired alternate target for the vessel based on at least the forecasted vessel density at the at least one alternate target; updating the route, such that the route comprises the plurality of edges from the current position of the vessel to the desired alternate target; and outputting the route to a control system associated with the vessel.

This enables the efficient calculation of alternate targets for a given route, based on factors which may occur during transit, or other events outside the control of the vessel operator resulting in increased vessel density at the destination which in turn means increased delays are likely. The use of a machine learning method enables a more accurate calculation of vessel density based on a number of factors, such as the weather, resource availability, and likelihood of industrial action to be accounted for when determining a suitable alternate target. By outputting the updated route an autopilot or other control system of an autonomous vessel may be kept up-to-date with any changes to the route, thereby minimising disturbance and delays further.

Optionally, a route map is obtained from storage, the route map comprising a plurality of nodes representing a real-world location, and a plurality of edges between the plurality of nodes, and wherein the route is based on the route map. Furthermore, the at least one alternate target may be one of the plurality of nodes of the route map. This enables accurate route maps to be provided which can be efficiently altered and adjusted using minimal resources based on large amounts of data, such as AIS data, whilst also considering a number of other factors such as vessel characteristics. This also enables autonomous components such as an autopilot system to be updated and facilitate the navigation of the vessel along the route. Since the routes are transmitted to the control system by efficiently processing the route and route maps, there is a more efficient use of resources especially when transmitting the route and/or route maps over a network as such the network requirements are reduced, as the route may be generated based on information available to the control system/stored in a memory associated with the control system.

Optionally, the characteristics of the at least one alternate target comprise at least one of weather data associated with the at least one alternate target at the estimated vessel arrival time; environmental characteristics associated with the at least one alternate target at the estimated vessel arrival time; historical wait times associated with the at least one alternate target; and delay-inducing factors associated with the at least one alternate target as the estimated vessel arrival time. This enables several factors to be considered when determining an alternate target, such as the weather at the alternat target, where a vessel may not be able to visit if the visibility information is below a given threshold. Such examples include ports where vessels are unable to dock when visibility is poor. Other conditions such as ocean current and/or wind speed in the vicinity of a vessel determined route can also affect the transit of the vessel along the route, and therefore by considering these attributes when calculating an alternate target increase the reliability of the desired alternate target, and whether it is worth adjusting/updating the route to include the alternate target.

The method may further comprise a step of determining whether to select the desired alternate target based on characteristics of the desired alternate target. By considering the whether to select the desired alternate target based on the characteristics it can be determined whether the alternate target is more efficient and/or more desirable than the original target of the route, thereby ensuring the most efficient and desirable route is provided to the control system.

### BRIEF DESCRIPTION OF DRAWINGS

Embodiments of the invention will now be described, by way of example only, with reference to the accompanying drawings, in which:

FIG. 1 is a schematic representation of a machine learning architecture representing a neural network according to an example;

FIG. 2 is a representation of AIS data according to an example;

FIG. 3 is a flowchart showing a method for determining an alternate target for a vessel, according to an example;

FIG. 4 is a representation of the AIS data applied to a plurality of nodes according to an example;

FIG. 5 is a representation of a route according to an example; and

FIG. 6 is a schematic representation of a system for determining alternate target for a vessel, according to an example.

### DETAILED DESCRIPTION

Accurately determining an alternate destination/target and a route for a vessel, such as an ocean-going vessel, is a complex and time-consuming process, especially when events occur during transit between a start point and an original destination. For example, weather conditions can have a large impact on the route chosen, especially for vehicles such as ships and aircraft. Being able to quickly and efficiently react to such changes is essential for ensuring smooth passage along a route, or an effective detour to an alternative destination.

With the advance of automated systems, such as autopilot, and/or autonomous controls for vessels, accurate route planning which can compensate for real-world changes, such as the weather or increased congestion, is increasingly important. Enabling the analysis of such changes and compensating for those changes in the route, such as a change to the destination or target of a route, is particularly important when dealing with such vessels. Allowing those vessels to intuitively and intelligently update central control systems or enabling a central control system to provide an update to the vessel, facilitates the quick and efficient passage along a route to a destination. Similarly, providing that information to a control system can also assist in the reprogramming of such automated systems, increasing the efficiency of the transit between an originating location and a destination. In some examples, the control system may comprise a display for indicating a user, such as an operator of the vessel, and/or the control system may comprise further processors or processing capabilities to automatically adjust and/or alter the route of the vessel, such as to a new destination or target. Furthermore, in the logistics industry, such updates enable clients and customers to be kept up to date with the estimated arrival time for a consignment, as well as enabling the clients and customers to be informed of any changes to the route. As such, on the adjustment of the route of the vessel by the control system, the control system may make notifications to one or more customers as to the updated destination.

There are several aspects to the system for determining routes for vessels and for determining updates to those routes. In many examples, machine learning methods and apparatus are used to quickly and efficiently analyse a large amount of information and provide an accurate output for the control systems of the vessels to further process.

### Machine Learning Model

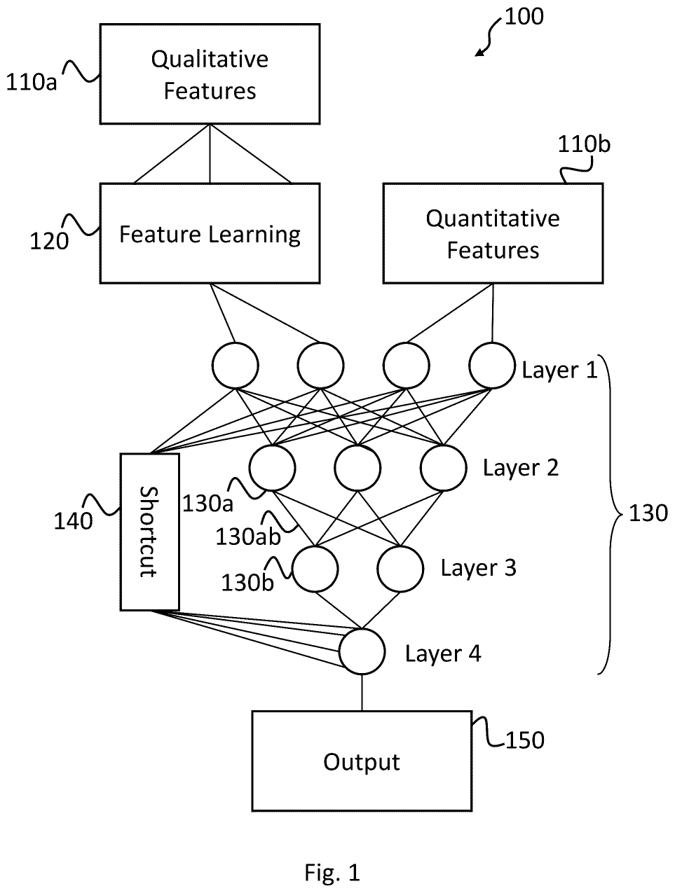

FIG. 1 shows an example of a machine learning model 100 which may be used to determine a new destination for a vessel, based on a route as well as other factors.

The machine learning method 100 is a neural network, configured to receive a number of inputs 110a, 110b, analyse them and produce an output 150. The analysis of the inputs is undertaken in many fully connected layers, however, it will be appreciated that in some examples, other types of neural network, such as a deep sequence model may be used, and the methodologies discussed below are not limited to using a particular type of neural network.

The machine learning method 100 comprises a plurality of layers 130, each configured to receive at least one input, either directly or from a preceding layer, and process it such that an output is produced. The output may then be provided to a subsequent layer, such as between Layer 1 and Layer 2, or as an output 150 to the machine learning model 100. Each of the layers 130 comprises at least one neuron 130a, 130b, which is configured to process at least one input and generate an output. Neurons 130a, 130b are often aggregated into layers based on the different operations on their inputs that they undertake. Outputs are then transmitted to other neurons 130a, 130b along connections 130ab. In some examples, each neuron 130a, 130b only transmits a signal along the connection 130ab to another neuron 130a, 130b if a threshold is met.

Neural networks, such as the machine learning model 100 of FIG. 1, are trained on training data which is arranged to refine the processing undertaken at leach neuron 130a, 130b. During the training process weights associated with each neuron 130a, 130b and connection 130ab are adjusted such that the strength of the connection is increased or decreased, thereby affecting whether the signal is transmitted along the connection 130ab to other neurons 130a, 130b based on the inputs 110a, 110b provided. Each layer may be traversed a number of times depending on the weighting and to ensure the most accurate overall output 150.

In some examples, the machine learning model 100 may comprise a shortcut 140, sometimes called a residual neural network which facilitates the skipping of layers, thereby simplifying the learning process, speeding up the learning and reducing the possibility of encountering a vanishing gradient. This can be achieved by grouping inputs 110a, 110b that are strongly linearly correlated with the output. For example, there is a strong correlation between the length of a route and the time required to transit that route.

The machine learning model 100 of FIG. 1, is arranged to receive a number of different inputs 110a, 110b. The inputs may include data such as the vessel features (i.e. length, manufacture data, type), current time information (i.e. the day, month, year), journey features (i.e. the start location, destination, previous destinations, distance remaining, predicted route, average time for other vessels to take that route), as well as other calculated information such as a scheduled arrival time. Furthermore, in some examples, data may be obtained from one or more other sources. In one such example, inputs may be obtained from the Automatic Identification System (‘AIS’), which uses transceivers on the vessels to obtain current locations and vessel information, similar to the transponder system used by aircraft. The AIS data includes information such as the vessel's current location, speed, weight, heading, draught, among other features.

The inputs 110a, 110b may be categorized as qualitative inputs 110a, or quantitative inputs 110b. Examples, of qualitative inputs 110a include, the destination, and the vessel type and size, whereas quantitative inputs 110b include the latitude/longitude and the vessel speed.

To improve training times, the qualitative inputs 110a may undergo pre-processing via feature learning 120. This enables some aspect of the training to be undertaken on those features before the main training of the machine learning model 120. By undertaking this pre-processing, the qualitative inputs 110a may be processed to quantify and categorize similarities between such qualitative inputs 110a. This thereby speeds up the training of the main machine learning model 100.

The output 150 may comprise more than one piece of information for use in the concepts described below. For example, when determining an estimated time of arrival, the output 150 may comprise both the estimated time of arrival prediction and a confidence estimate. The confidence estimate portion of the output 150 may utilize a Bayesian dropout over several predictions to determine a probability distribution and thereby indicate whether a given prediction is likely to be more accurate than another prediction. Similarly, previous predictions may be used to indicate an average prediction error to indicate whether a particular output based on a given input is more or less likely to be correct, or within a given allowable range. Therefore, if new criteria/information is provided to the machine learning model 100 the output can indicate whether this is likely to increase or decrease the confidence in the output 150. This additional confidence level can be provided to a control system and analysed alongside the main output to determine whether a given action should be taken based on this information. For example, where the confidence output indicates that the confidence is low, further predictions and/or analysis may be undertaken before the control system indicates a particular action given the uncertainty in the output 150. In one example, before the action is taken a further analysis may be undertaken, such as at a later time during the vessel's transit which may result in a more accurate output and therefore higher confidence. Conversely, where the confidence output indicates the confidence is high, the control system may perform the particular action as the model indicates that the output 150 is likely very accurate.

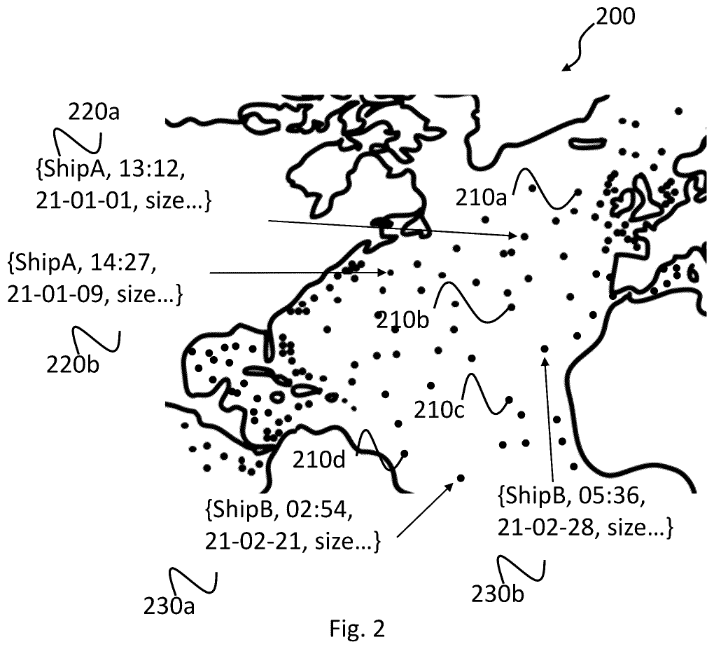

The machine learning model 100 may be implemented as part of the invention described below in relation to FIGS. 2 to 6 although it will be appreciated that the machine learning model may be implemented in relation to any number of other inventions whereby it is necessary to obtain an estimated time of arrival or any other estimated time based on a number of inputs. Similarly, whilst the example shown in FIG. 1 has four layers, it will be understood that the machine learning model may have any number of layers.

### Determining an Alternate Vessel Destination/Target

Determining a route for a vessel between two points, an origin and a destination, is a complex task and is dependent upon a number of inputs. For example, the type of vessel, the size of the vessel, and congestion in and around the potential routes can all affect the most optimal route. Whilst the examples described below relate to the determination of a route for a vessel, such as a ship, it will be appreciated that the method and system described may be utilised for determining alternate destinations/targets for any type of vehicle, such as a car, delivery truck, or aircraft.

Determining a route for a vessel is not always a simple task due to the nature of the available route, for example, sea lanes for ships. The direct great-circle distance, which accounts for the curvature of the Earth over long distances is not always applicable, and simply dividing the Earth into a grid does not scale due to the different high- and low-density areas. That is large numbers of grid points are generated for areas of the Earth where the vessel would never travel, such as the Arctic and a large portion of the Pacific Ocean, or in the case of a ship, over land.

FIG. 2 shows a representation 200 of AIS data obtained in an example for the Atlantic Ocean. The AIS data comprises a plurality of points 210a, 210b, 210c, 210d which each represent ship locations at a given time. For example, a first ship, ShipA has at least two data points within the AIS data. The first data point 220a indicates the location of ShipA at 13:12 on 1 Jan. 2021, along with at least a size characteristic. The second data point 220a indicates the location of ShipA at 14:27 on 9 Jan. 2021. Similarly, a second ship ShipB also has at least two data points within the AIS data, the first data point 230a indicates the location of the ShipB at 02:54 on 21 Feb. 2021 along with at least a size characteristic. The second data point indicates the location of ShipB at 05:36 on 28 Feb. 2021. It will be appreciated that there may be other data points representing the locations of ShipA and ShipB within the data set between the two data points selected. Each data point may also include other attributes such as the heading, width, length, draught, gross tonnage, and current destination.

In some examples, the size characteristic associated with each data point may be used to group the data points for filtering. For example, where the vessel a route is being determined for is above a given size, and is classed as a NeoPanamax ship, then the data points which include vessels capable of transiting the Panama Canal may be excluded since they cannot be used to determine a route for the vessel since it is too large to fit through the Panama Canal.

There are many methods for filtering and/or reducing the data set into a number of nodes. For example, a K-means clustering algorithm may be applied to the historical data, where K is set to the number of nodes required. In some examples, K may be set to 50,000 to provide a sufficient number of nodes whilst enabling efficient processing. It will be appreciated that other methods of clustering the nodes may be used such as a distribution or density-based clustering method.

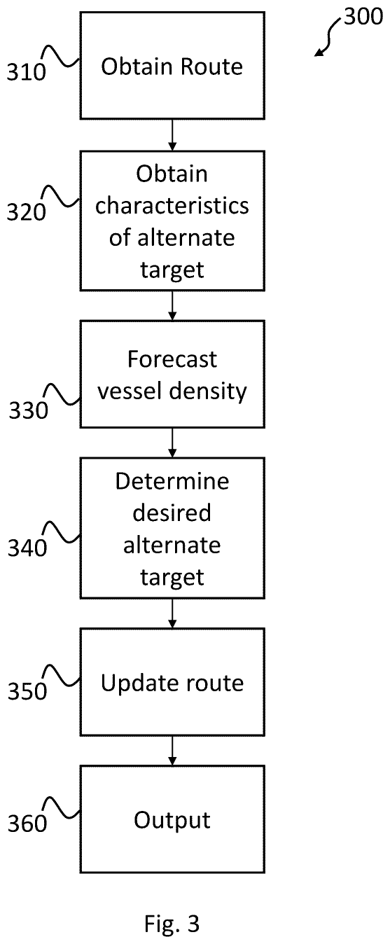

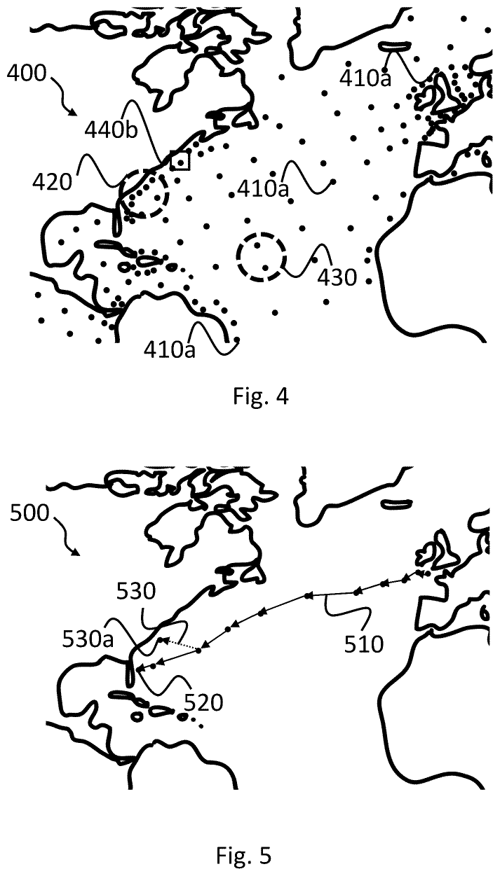

FIG. 3 shows a method 300 for determining an alternate target for a vessel, which overcomes the issues mentioned above. At step 310, method 300 obtains a route. The route may comprise a number of edges connected to a number of nodes based on the AIS data 200 (or other data) described above in relation to FIG. 2. In some examples, the AIS 200 (or other data) may be used to generate a number of nodes. FIG. 4 shows a representation 400 of the nodes 410a, 410b, 410c determined/generated for vessels based on AIS data 200. The nodes 410a, 410b, 410c are distributed across the area based on the density of the data points in the AIS data 200. For example, the nodes for areas nearby a coastline such as those indicated in group 420 are much closer together than the nodes in the middle of the ocean such as those indicated in group 430. The route, such as route 510 shown in representation 500, may comprise a plurality of nodes based on the AIS data, as shown in FIG. 4, and comprise edges between those nodes.

Based on the route obtained from the vessel, at step 320 characteristics of one or more potential alternate targets are obtained. Potential alternate targets may be one or more of the plurality of nodes nearby a coastline and within a given vicinity of the destination of the obtained route. In some examples, the potential alternate targets may also be based on a transit time to the alternate target from the current position of the vessel. For example, nodes nearby the coastline, such as those indicated in group 420 may be representative of a suitable alternate target, and indicative of a port capable of receiving the vessel whose original destination was the port indicated by node 440.

For each of the potential alternate targets, such as those nodes forming part of group 420, characteristics may be obtained. For example, the characteristics of a given alternative target may include weather data associated with the alternate target. The weather data obtained may be based on forecasted weather for a given time period. Other characteristics which may be obtained include environmental characteristics associated with the alternate target, these environmental characteristics include, but are not limited to characteristics of the port such as depth, which when combined with the known vessel size may be indicative of whether the vessel is capable of berthing, the available facilities for loading/unloading cargo, and even characteristics such as the fuel types available (e.g., diesel fuel or liquified natural gas).

In addition to characteristics representative of conditions relating to the weather and location of a potential alternate target other delay-inducing factors may also be taken into account, for example, whether there is industrial action at a port associated with the alternate target, there is a lack of available resources, such as cargo containers, and/or lack of space for temporarily storing cargo.

It will be appreciated that other factors associated with the current characteristics of the potential alternate target may also be obtained. In addition, characteristics associated with a preceding time may also be obtained. For example, historical data associated with the potential alternate target may be obtained, the historical data may include weather data, industrial action data, or any other type of data which were relevant for determining whether there is likely to be an effect on the arrival of a vessel at that alternate target. Such data may include previous wait times for vessels to enter a port following arrival at an associated node, in yet further examples the wait times may be categorised based on vessel characteristics, such as size, weight, and cargo type.

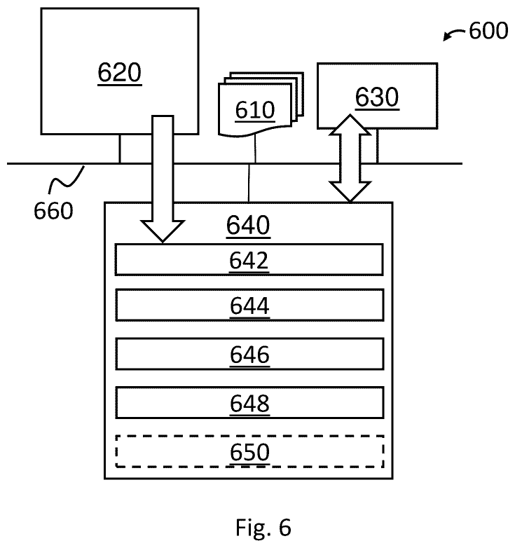

The characteristics of the alternate targets may be obtained from storage (e.g., in the case of historical information), either local to or external from the vessel, or from a remote server (e.g., such as a weather server), as will be described in further detail below with reference to FIG. 6.

Once the characteristics of at least one of the alternate targets have been obtained, at step 330, the vessel density for at least one of the alternate targets is forecasted. The vessel density for the at least one alternate target may be determined using a trained machine learning model, such as the trained machine learning model 100 described above in relation to FIG. 1, such that the trained machine learning model 100 is configured to output a vessel density at a given estimated arrival time of the vessel at the at least one alternate target. The trained machine learning model 100 may receive a number of the characteristics obtained in relation to the at least one alternate target, as well as other characteristics and real-world factors.

In some examples, the trained machine learning model 100 may be configured to receive multiple alternate targets and their associated characteristics and provide the vessel densities at each of the alternate targets. Furthermore, it may be desirable to incorporate a number of other features into the determination of the vessel densities, such as a delay (whether a positive delay or negative delay) to determine whether the vessel density may be more favourable should the vessel speed up or slow down for a given alternate target.

Similarly, in some examples, the trained machine learning model 100 may be configured to receive characteristics associated with the original target of the route and determine the vessel density at the arrival time of the vessel at the original target based on those characteristics.

Once the vessel density has been determined for at least one of the alternate targets for the vessel, at step 340 a desired alternate target is determined. The desired alternate target may be based solely on the vessel density determined in relation to step 330, and in some examples, may also be based on a number of other factors, such as the vessel density calculated in relation to the original target. It will be appreciated that the determination may be based on any number of factors, not only a more preferable vessel density at the alternate target. For example, the vessel density may be used to filter a list of potential alternate targets, however, other factors such as distance and/or time to each of the potential alternate targets may also be considered as part of the determination.

Once the desired alternate target has been determined, at step 350, the route is updated such that it comprises a plurality of edges from the current position of the vessel to the desired alternate target. FIG. 5 shows is a schematic representation 500 comprising an exemplary route 510 which has a plurality of edges between nodes, such as the nodes described above in relation to FIG. 4. The route 510 comprises a plurality of edges between nodes and had an original target represented by node 520. Following the forecasting undertaken at step 330 by the trained machine learning model 100, and the determination of a desired alternate target at step 340, the route 520 is updated such to include an edge 530 from the current position of the vessel to the node 530a representative of the desired alternate target. In some examples, it may not be desirable to select the desired alternate route over the original route. In such examples, the processor 640 may comprise a target selection module 650 configured to determine whether it is more beneficial to select the alternate target or to maintain the route with the original target.

Following the updating of the route 510, the route is output, at step 360, to a control system of a vessel. The control system may comprise a display or other processing component, such as an autopilot system enabling quick and efficient updates to the route to be provided to clients and/or operators.

In some embodiments, the method 300 may be implemented as part of a system. FIG. 6 is a schematic example of a system 600 for determining an alternate target for a vessel. The system comprises storage 610 for storing routes comprising a plurality of nodes which form part of a route map, such as the nodes described above with reference to FIG. 4, a remote server 620 at least one processor 640 for determining an alternate target for a vessel, and a control system 630 associated with the vessel, for receiving the updated route. In some examples, the control system 630 associated with the vessel may be capable of sending, to the processor 640 the route comprising a plurality of edges, such as route 520. The storage 610, the remote server 620 at least one processor 640, and the control system 630 may all be interconnected with one another either as part of a single system or a remotely connected system. The interconnection may be via a system bus 660, or other wired or wireless connection enabling the components of the system to communicate across a network such as the Internet. For example, the storage 610 may be remote storage, such as cloud storage, or hard drives forming part of a remote server.

The remote server 620 is configured to provide characteristics for at least one alternate target for the vessel. The remote server 620 may comprise storage for storing historical data, and may also comprise a connection to a network, such as the Internet to obtain further information such as weather forecasts, information relating to industrial action, or to connect to another service provider, e.g., to obtain information relating to the capacity at a port, available space for storing container and/or cargo, and worker availability, as described above in relation to method 300.

The processor 640 comprises a forecasting module 642 for forecasting the vessel density at the at least one alternate target, at an estimated arrival time of the vessel. The vessel density for the at least one alternate target may be determined using a trained machine learning model, such as the trained machine learning model 100 described above in relation to FIG. 1, such that the trained machine learning model 100 is configured to output a vessel density at a given estimated arrival time of the vessel at the at least one alternate target. The trained machine learning model 100 may receive a number of the characteristics obtained from the remote server 620 in relation to the at least one alternate target, as well as other characteristics and real-world factors. The forecasting module 642, or the processor 640 as a whole, may be a machine learning processor, or specific neural processing unit configured and/or optimized to undertake machine learning processing.

Following the forecasting, a determination module 644 associated with the processor 640 determines a desired alternate target for the vessel based on the forecasted vessel density generated by the forecasting module 642. The desired alternate target may be based solely on the vessel density determined by the forecasting module 642, however, in some examples, it may also be based on a number of other factors, such as the vessel density calculated in relation to the original target. It will be appreciated that the determination may be based on any number of factors, not only a more preferable vessel density at the alternate target. For example, the vessel density may be used to filter a list of potential alternate targets, however, other factors such as distance and/or time to each of the potential alternate targets may also be considered as part of the determination.

An updating module 646 associated with the processor 640, subsequently updates the route based on the desired alternate target determined by the determination module 644. The route is updated such that it comprises a plurality of edges from the current position of the vessel to the desired alternate target. FIG. 5 shows is a schematic representation 500 comprising an exemplary route 510 which has a plurality of edges between nodes, such as the nodes described above in relation to FIG. 4. The route 510 comprises a plurality of edges between nodes and had an original target represented by node 520. The route 520 is updated by the updating module 646 so as to include an edge 530 from the current position of the vessel to the node 530a representative of the desired alternate target.

Following the updating of the route 510, the route is output by an output module 648 associated with the processor 640, to a control system 630 associated with the vessel. The control system may comprise a display or other processing component, such as an autopilot system enabling quick and efficient updates to the route to be provided to clients and/or operators.

In some examples, it may not be desirable to select the desired alternate route over the original route. In such examples, the processor 640 may comprise a target selection module 650 configured to determine whether it is more beneficial to select the alternate target or to maintain the route with the original target.

### CONCLUSION

At least some aspects of the embodiments described herein with reference to FIGS. 1-6 comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

It is to be understood that although some aspects of the disclosure above relates to the use of cloud computing, the implementation described is not limited to a cloud computing environment. Rather, embodiments of the present disclosure are capable of being implemented in conjunction with any other type of computing environment.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above embodiments are to be understood as illustrative examples of the disclosure. Further embodiments of the disclosure are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

1. A method for determining an alternate target for a vessel, the method comprising the steps of:
obtaining, from the vessel, at least a route, the route comprising a plurality of edges from a current position of the vessel, to at least a desired target;
obtaining, from a remote server, characteristics of at least one alternate target, the characteristics comprising at least historical vessel density data associated with at least one alternate target;
forecasting, using a trained machine learning model, vessel density at the at least one alternate target, at an estimated vessel arrival time for the vessel at the at least one alternate target based on the characteristics;
determining a desired alternate target for the vessel based on at least the forecasted vessel density at the at least one alternate target;
updating the route, such that the route comprises the plurality of edges from the current position of the vessel to the desired alternate target; and
outputting the route to a control system associated with the vessel.

2. The method for determining an alternate target for a vessel according to claim 1, further comprising obtaining a route map from storage, the route map comprising a plurality of nodes representing a real-world location, and a plurality of edges between the plurality of nodes, and wherein the route is based on the route map.

3. The method for determining an alternate target for a vessel according to claim 2, wherein the at least one alternate target is one of the plurality of nodes of the route map.

4. The method for determining an alternate target for a vessel according claim 1, wherein the characteristics of the at least one alternate target comprise at least one of:
weather data associated with the at least one alternate target at the estimated vessel arrival time;
environmental characteristics associated with the at least one alternate target at the estimated vessel arrival time;
historical wait times associated with the at least one alternate target; and
delay-inducing factors associated with the at least one alternate target as the estimated vessel arrival time.

5. The method for determining an alternate target for a vessel according to claim 1, further comprising a step of determining whether to select the desired alternate target based on characteristics of the desired alternate target.

6. A system for determining an alternate target for a vessel, the system comprising:
a control system associated with the vessel configured to receive a route comprising the alternate target for the vessel;
storage for storing at least one route, the route comprising a plurality of edges from a current position of the vessel to at least a desired target;
a remote server configured to provide characteristics for at least one alternate target, the characteristics comprising at least historical vessel density data associated with the at least one alternate target; and
a processor configured to determine the alternate target for the vessel, the processor comprising:
a forecasting module for forecasting, using a trained machine learning model, vessel density at the at least one alternate target, at an estimated vessel arrival time for the vessel at the at least one alternate target, based on the characteristics;
a determination module for determining a desired alternate target for the vessel based on the forecasted vessel density at the at least one alternate target;
an updating module for updating the route, such that the route comprises a plurality of edges from the current position of the vessel to the desired alternate target; and
an output module for outputting, to the control system, the route comprising the desired alternate target.

7. The system for determining an alternate target for a vessel according to claim 6, wherein the storage is further configured to store a route map comprising a plurality of nodes representing a real-world location, and a plurality of edges between the plurality of nodes, and wherein the route is based on the route map.

8. The system for determining an alternate target for a vessel according to claim 6 or claim 7, wherein the processor is a machine learning processor configured to execute the trained machine learning model.

9. The system for determining an alternate target for a vessel according to claim 6, further comprising a target selection module for determining whether to select the desired alternate target based on characteristics of the desired alternate target.

10. A computer-readable storage medium, storing instructions that, when executed by a processor, cause the processor to determine an alternate target for a vessel, the instructions comprising:
obtaining, from the vessel, at least a route, the route comprising a plurality of edges from a current position of the vessel, to at least a desired target;
obtaining, from a remote server, characteristics of at least one alternate target, the characteristics comprising at least historical vessel density data associated with at least one alternate target;
forecasting, using a trained machine learning model, vessel density at the at least one alternate target, at an estimated vessel arrival time for the vessel at the at least one alternate target, based on the characteristics;
determining a desired alternate target for the vessel based on at least the forecasted vessel density at the at least one alternate target;
updating the route, such that the route comprises the plurality of edges from the current position of the vessel to the desired alternate target; and
outputting the route to a control system associated with the vessel.
